(19) United States
(12) Patent Application Publication
(10) Pub. No.: US 2012/0116909 A1
(43) Pub. Date: May 10, 2012

(54) REVERSE BIDDING SYSTEM AND METHOD

(76) Inventor: Julio Cesar Saenz, El Paso, TX (US)

(21) Appl. No.: 13/290,774

(22) Filed: Nov. 7, 2011

Related U.S. Application Data
(60) Provisional application No. 61/411,269, filed on Nov. 8, 2010.

(51) Int. Cl. G06Q 30/08

(52) U.S. Cl. 705/26.3

(57) ABSTRACT

A reverse bidding system and method are disclosed. A reverse auction occurs when the price of an item to be sold decreases over time with each bid. A potential buyer bids to view a decreasing current price of an item. The current price and/or availability status of an item can be hidden from view from a potential buyer. The potential buyer has the option to purchase the item at the current price when it is revealed following the potential buyer's bid. The seller can choose to wait for a specified time while the potential buyer makes a decision to purchase the item. With an increased quantity of bids to view the current price of an item, the price of the item can approach $0.00. If the item's price reaches $0.00, the item is sold by default to the last user who bid to view the price of the item.

### CROSS REFERENCE TO RELATED APPLICATIONS

This patent application claims the benefit under 35 U.S.C. §119(e) of U.S. Provisional Patent Application Ser. No. 61/411,269 filed on Nov. 8, 2010, and entitled “Reverse Bidding System and Method,” which is hereby incorporated by reference in its entirety.

### TECHNICAL FIELD

The disclosed embodiments relate to a computerized bidding system. The disclosed embodiments also relate to a reverse auction. The disclosed embodiments further relate to a reverse auction where a potential buyer bids to view a current price of an item.

### BACKGROUND OF THE INVENTION

Auctions offer a popular forum for purchasing items, services, vacations, event tickets, etc. With auction systems, there is the possibility to obtain the product at a very competitive price. In a conventional auction, an item is sold to a highest bidder. Two common forms of conventional auctions are an English auction and a silent auction. In the English auction, a plurality of bidders place public bids on an item. The final bidder (i.e., the highest bidder) purchases the item for the offered bid price. Traditionally, the buyer in a conventional auction does not have the power to end the auction prior to a specified time or before all the bids are offered. In a silent auction, a bidder offers a private, written bid price for an item during a specified amount of time. The highest bidder purchases the item for the listed price at the end of the allotted silent auction time frame.

Auctions via the internet are an enormously popular means to purchase items. Conventional Internet auctions have sellers placing items on a web site for potential purchasers to bid over a certain time. Details of the bid are posted on the auction site for potential auction participants to review. Once a specified time has ended, the highest bidder purchases the auctioned item. Buyers also have the power to purchase items at a specified “reserves price” outside of the auction process.

Accordingly, there exists a need for an improved reverse bidding system and method where a potential buyer bids to view the decreasing current price of an item and thereafter decides whether to accept an offer to purchase an item.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is therefore an object of the disclosed embodiments to provide for a computerized bidding system.

It is another object of the disclosed embodiments to provide a reverse auction process.

It is an additional object of the disclosed embodiments to provide a reverse auction where a potential buyer bids to view a current price of an item.

The above and other aspects can be achieved as is now described. A reverse bidding system and method are disclosed. A reverse auction occurs when the price of an item to be sold decreases over time with each bid. A potential buyer bids to view a decreasing current price of an item. The current price and/or availability status of an item can be hidden from view from a potential buyer. The potential buyer has the option to purchase the item at the current price when it is revealed following the potential buyer's bid. The seller can choose to wait for a specified time while the potential buyer makes a decision to purchase the item. With an increased quantity of bids to view the current price of an item, the price of the item can approach $0.00. If the item's price reaches $0.00, the item is sold by default to the last user who bid to view the price of the item.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates an exemplary data-processing apparatus, which can be utilized in accordance with the disclosed embodiments;

FIG. 2 illustrates an exemplary schematic view of a software system including an operating system, application software, and a user interface for carrying out the disclosed embodiments, in accordance with the disclosed embodiments;

FIG. 3 illustrates a flow chart of operations illustrating a method for a reverse auction, in accordance with the disclosed embodiments; and

FIG. 4 illustrates a flow chart of operations illustrating exemplary bids in a reverse auction, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one skilled in the art, one or more of the disclosed embodiments can be embodied as a method, system, or computer program usable medium or computer program product. Accordingly, the disclosed embodiments can in some instances take the form of an entire hardware embodiment, an entire software embodiment or an embodiment combining software and hardware aspects all generally referred to herein as a “module”. Furthermore, the disclosed embodiments may take the form of a computer usable medium, computer program product, a computer-readable tangible storage device storing computer program code, the computer program code comprising program instructions executable by the processor on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language or in a programming environment such as, for example, Visual Basic.

The program code may execute entirely on the user's computer, partly on the users computer, as a stand-alone software package, partly on the users computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The disclosed embodiments are described in part below with reference to flowchart illustrations and/or block diagrams of methods, systems, computer program products, and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

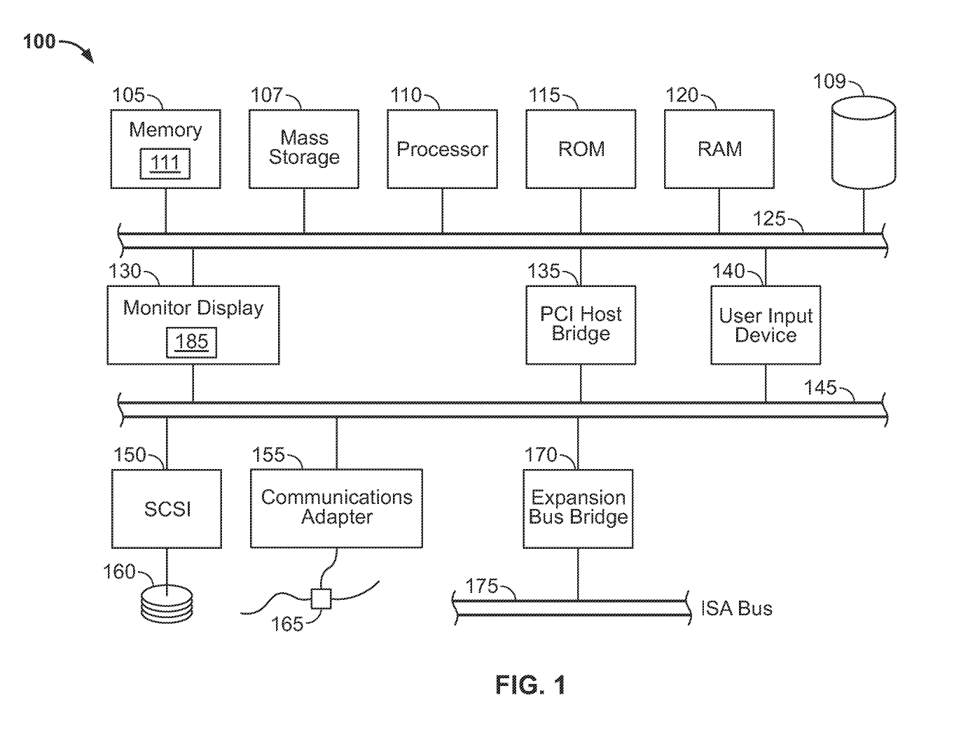

FIG. 1 illustrates a block diagram of a sample data-processing apparatus 100, which can be utilized for an improved reverse bidding system and method. Data-processing apparatus 100 represents one of many possible data-processing and/or computing devices, which can be utilized in accordance with the disclosed embodiments. It can be appreciated that data-processing apparatus 100 and its components are presented for generally illustrative purposes only and do not constitute limiting features of the disclosed embodiments. The disclosed embodiments can also be implemented in the context of a live auction system without the use of a computer-implemented method and system.

As depicted in FIG. 1, a memory 105, a mass storage 107 (e.g., hard disk), a processor (CPU) 110, a Read-Only Memory (ROM) 115, and a Random-Access Memory (RAM) 120 are generally connected to a system bus 125 of data-processing apparatus 100. Memory 105 can be implemented as a ROM, RAM, a combination thereof, or simply a general memory unit. Module 111 includes software module in the form of routines and/or subroutines for carrying out features of the present invention and can be additionally stored within memory 105 and then retrieved and processed via processor 110 to perform a particular task. A user input device 140, such as a keyboard, mouse, or another pointing device, can be connected to PCI (Peripheral Component Interconnect) bus 145. Note that the term “GUI” generally refers to a type of environment that represents programs, files, options, and so forth by means of graphically displayed icons, menus, and dialog boxes on a computer monitor screen.

Data-process apparatus 100 can thus include CPU 110, ROM 115, and RAM 120, which are also coupled to a PCI (Peripheral Component Interconnect) local bus 145 of data-processing apparatus 100 through PCI Host Bridge 135. The PCI Host Bridge 135 can provide a low latency path through which processor 110 may directly access PCI devices mapped anywhere within bus memory and/or input/output (I/O) address spaces. PCI Host Bridge 135 can also provide a high bandwidth path for allowing PCI devices to directly access RAM 120.

A communications adapter 155, a small computer system interface (SCSI) 150, and an expansion bus-bridge 170 can also be attached to PCI local bus 145. The communications adapter 155 can be utilized for connecting data-processing apparatus 100 to a network 165. SCSI 150 can be utilized to control high-speed SCSI disk drive 160. An expansion bus-bridge 170, such as a PCI-to-ISA bus bridge, may be utilized for coupling ISA bus 175 to PCI local bus 145, Note that PCI local bus 145 can further be connected to a monitor 130, which functions as a display (e.g., a video monitor) for displaying data and information for a user and also for interactively displaying a graphical user interface (GUI) 185. A user actuates the appropriate keys on the GUI 185 to select data file options.

A database 109 can contain information on a variety of matters such as data related to facilitating an online product exchange that enables an operator to match purchase requests with offers to sell. Database 109 may contain buyer profiles, seller profiles, product profiles, and/or exchange configuration information. A buyer profile may include, but is not limited to, a buyer identifier such as user name, a password, contact information, mailing information, billing information, saved product searches, and/or user preferences for use in searching database 109 and/or displaying product searches. A seller profile may include, for example, seller identifier such as a user name, a password, contact information, mailing and/or shipping information, billing and/or invoicing information, and/or offer information. In some embodiments, offer information includes only an offer to sell at a designated price as specified by a seller.

The database 109 also maintains item, good, or service information including, for example, a UPC code, a product description, an auction date and time, a current item quantity, a starting price for the auction, a closing price for the auction, a large product image, a small product image, product carry, warranty cost, a minimum cost, a designation whether a warranty is available, an auction end time, a product catalogue, a product weight which is used as part of the shipping costs, an extended product description, a product street price, and a product vendor allocation as well as an auction product number. The database 109 maintains each of the products with a time designation associated therewith as this time designation control is used by the system to determine what products can be browsed by the users,

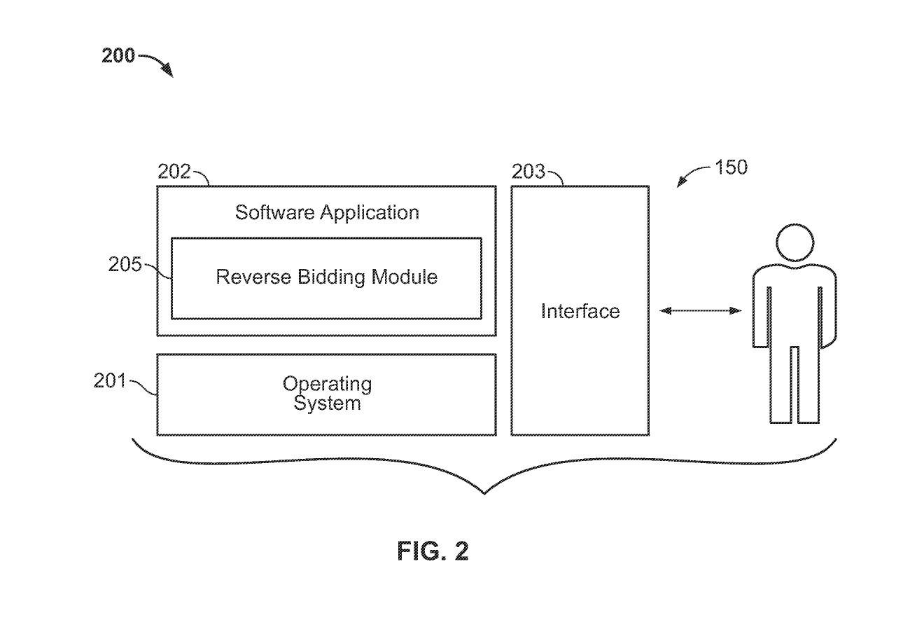

FIG. 2 illustrates a schematic view of a software system 200 including an operating system, application software, and a user interface for carrying out the disclosed embodiments, Computer software system 200 directs the operation of the data-processing system 100 depicted in FIG. 1. Software application 202, stored in main memory 105 and on mass storage 107, includes a kernel or operating system 201 and a shell or interface 203. One or more application programs, such as software application 202, may be “loaded” (i.e., transferred from mass storage 107 into the main memory 102) for execution by the data-processing system 100. The data-processing system 100 receives user commands and data through the interface 203, as shown in FIG. 2. The user's command input may then be acted upon by the data-processing system 100 in accordance with instructions from operating module 201 and/or application module 202.

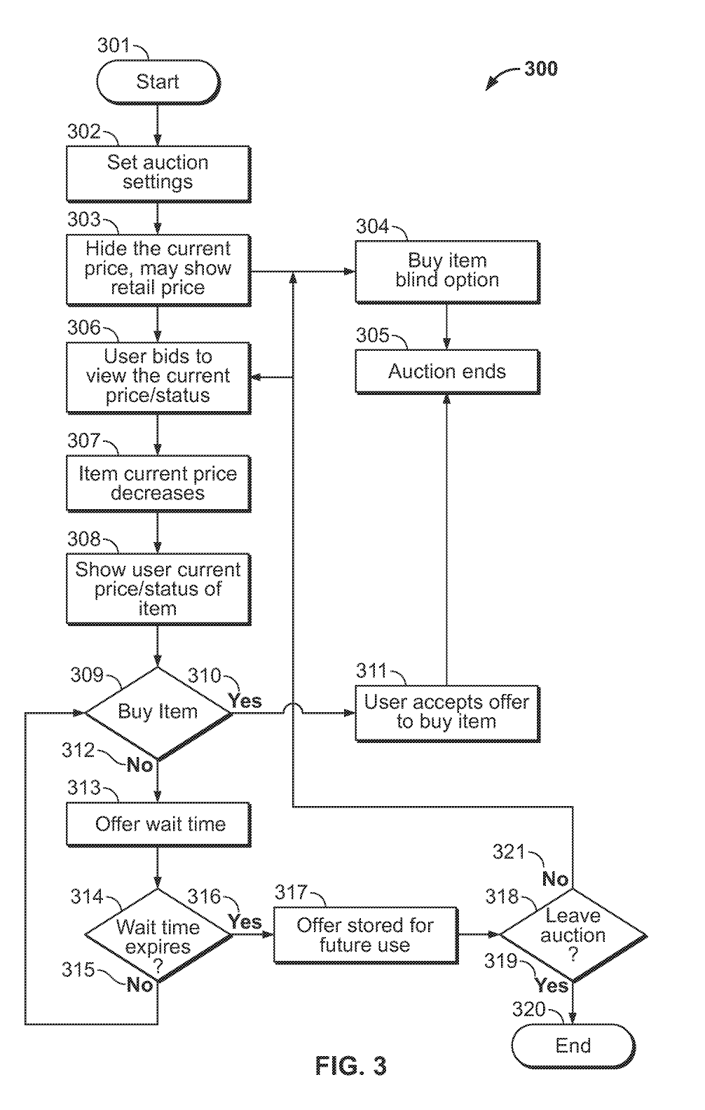

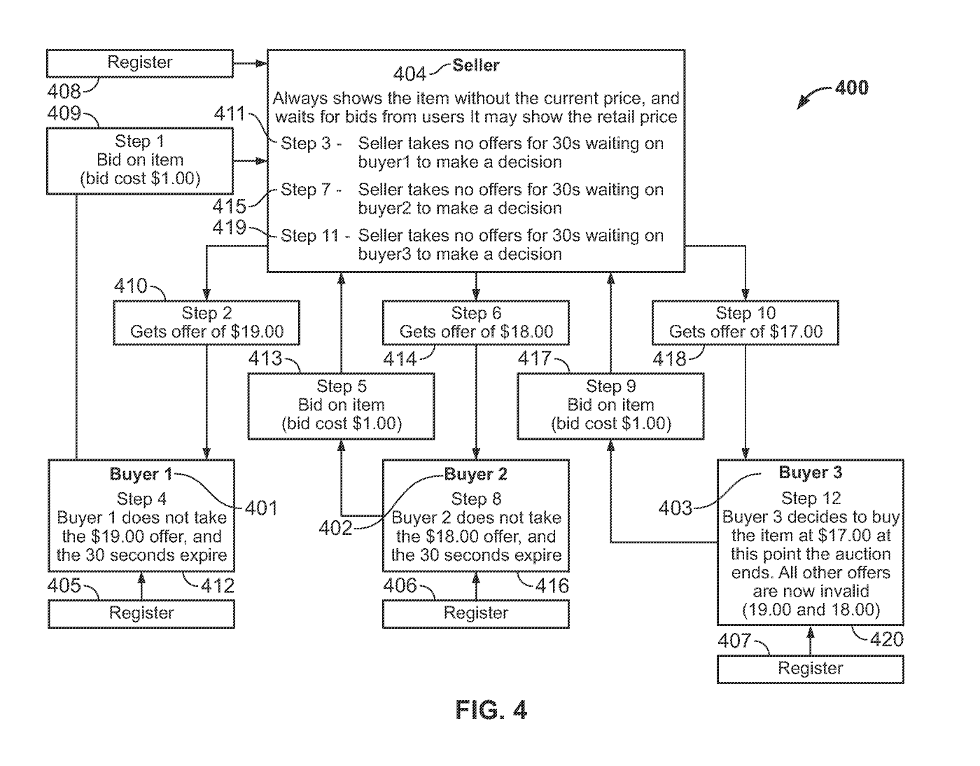

In an embodiment, operating system 201 and interface 203 can be implemented in the context of a “Windows” system. It can be appreciated, of course, that other types of systems are possible. For example, rather than a traditional “Windows” system, other operating systems such as, for example, Linux may also be employed with respect to operating system 201 and interface 203. The software application 202 can include a reverse bidding module 205 that can be adapted to provide a reverse bidding system and method, as described in greater detail herein. The software application 202 can also be configured to communicate with the interface 203 and various components and other modules and features as described herein. The reverse bidding module 205, in particular, can implement instructions for carrying out, for example, the embodiments depicted in FIGS. 3 and 4, respectively, as described below, and/or additional operations as described herein.

The embodiments described herein can be implemented in the context of a host operating system and one or more modules. Generally, program modules include routines, programs, objects, components, data structures, etc., that perform particular tasks or implement particular abstract data types. Moreover, those skilled in the art will appreciate that the disclosed method and system may be practiced with other computer system configurations such as, for example, hand-held devices, multi-processor systems, microprocessor-based or programmable consumer electronics, Smartphones, networked PCs, minicomputers, mainframe computers, and the like.

Software modules generally can include instruction media storable within a memory location of an image processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term “module” as utilized herein can therefore generally refer to software modules or implementations thereof. Such modules can be utilized separately or together to form a program product that can be implemented when storing computer-readable instructions in a computer-usable tangible data storage device. An example of such a module that can embody features of the present invention is a reverse bidding module 205, depicted in FIG. 2.

FIG. 3 illustrates a flow chart of operations illustrating a method 300 for a reverse auction, in accordance with the disclosed embodiments. A reverse auction occurs when the price of an item to be sold decreases over time and is to be contrasted with a conventional auction when the price increases over time. As time passes at a reverse auction, the price of an item declines whereas at a conventional auction, the price increases. Thus, a delay in bidding in a reverse auction can improve the chances that a potential bidder will pay less for an item whereas a delay at a conventional auction will increase the chances that a bidder will pay more.

The reverse bidding auction is initiated at block 301 with an exemplary single user entering the auction. A user as used herein can also refer to a “buyer” or bidder”. The user could be entering the reverse auction at the beginning of the auction or at any point after the auction begins. The auction starts by establishing and setting all the rules and settings that will govern the auction, as illustrated in block 302. Exemplary reverse auction settings can include, for example: identifying different products to be auctioned, assigning to each product a designated time for the product to be auctioned, auction length per product, promoting the product and the designated time of the auction prior to the auction to increase awareness of the product, assigning length of offer wait times, providing each potential purchaser with a designated actuation control for instructing the computer site of the decision to purchase the product at the current price at the time of receiving the instructions and registering potential purchasers and obtaining, recording financial data for automated payment of a purchased product, the starting current price, how much a bid will cost, how much does a bid bring the current price down, will there be an offer to the user after every bid, how will the offers expire, etc.

The current price and/or availability status of an item can be hidden from view from a user, as illustrated in block 303. The price for an item, good, or service (i.e., item) can be initially listed at a price/status at its retail or wholesale price greater than $0.00, for example. This contrasts with prior auction systems where the price of items, goods, and services is initially listed at $0.00 and the bidding serves to increase the price of the item. It is understood that the exemplary use of U.S. Currency illustrates one implementation of an embodiment and does not limit implementation of the disclosed invention using any type of monetary denomination, or other form of payment.

At any point in the auction, the user can choose to buy the item “blindly” without knowing the current price for an item, as illustrated in block 304, after which, the auction ends, as illustrated in block 305. If the user does not want to blindly purchase an item, a user pays a certain amount of money (i.e., “bid”) to view, or discover, the current price of an item, as illustrated in block 306. The price of that item, known as the current price, decreases per user bid, as illustrated in block 307. After every bid, the current price and/or availability status of the item is shown to the user, as illustrated in block 308. The availability status can include, for example, the number of units left and/or the number of purchases indicated during the auction process. Alternatively, the seller may only show the price and/or availability status of the item, but may not present an offer to purchase to the user.

The user may have the option from the seller to purchase the item at the current price, as illustrated in block 309. If the user decides to buy 310 the item at a current price, the user accepts the offer to buy the item, as illustrated in block 311 and the auction ends, as illustrated in block 305. If the user does not decide to purchase the item 312, the user can wait to decide on accepting the offer, as illustrated in block 313. A certain amount of wait time such as, for example, thirty seconds can be allotted for a particular user to decide on accepting an offer to purchase an item, as illustrated in block 314. During that wait time, other bids from other users can be refused. The user can decide to purchase an item before the wait time expires 315. Offers to purchase the item expire when a good is sold, a specific amount of time expires, and/or too many users have paid to reveal the price of that item and the current price approaches or decreases to $0.00. By refusing the offer, the user risks that another user will bid to see the price/status and subsequently purchase the item. If an allotted wait time expires 316, a buyer's offer can be stored for future use, as illustrated in block 317.

The user then has the option to leave that particular auction, as illustrated in block 318. If the user leaves that auction 319, the bidding process ends, as illustrated in block 320. If the user decides to remain in the auction 321, the user can place another bid to discover the new current price of that item, as illustrated in block 306. The user can also choose the buy blind option, as illustrated in block 304. When a seller accepts an offer for an item, the auction ends, as illustrated in block 305. If no users bid to view the price of an item, the seller refuses to sell an item, or the item's price and/or quantity available reaches zero, then the item is sold by default to the last user who bid to view the price of the item, and any additional processing or shipping fees.

FIG. 4 illustrates a flow chart of operations 400 illustrating exemplary bids in a reverse auction, in accordance with the disclosed embodiments. The disclosed embodiments use competition to force potential buyers to compete for the lowest possible price for an item before a user purchases an item. Multiple users 401, 402, 403 can submit bids either simultaneously or consecutively. Prior to using the system, both buyers 401, 402, 403 and sellers 404 can preferably set up an account by registering 405, 406, 407, 408 with the reverse auction system. This registration allows the reverse auction system to ascertain the identity and/or integrity of the potential 401. 402, 403 and sellers 404. There may be a prequalifying credit check or some other requirements that must be satisfied before a registration is considered valid by the system. The registration 405, 406, 407, 408 also allows the system to set up and keep track of user preferences and history as part of a user profile. Keeping track of user accounts or profiles may be useful in allowing the system to record historical information about the buyers and suppliers so that some or all parties may utilize the system more effectively. Examples of this type of information may include the buyer's name, email address, and telephone and fax numbers. Buyers may also be required to select a login name (i.e., screen name) and a password for verification purposes in future auction sessions.

The following reverse auction example is provided for illustrative purposes of the disclosed embodiments and is not intended to limit the disclosure in any way. As illustrated in FIG. 4, Buyer 1 401 bids $1.00 to view the current price of the seller's 404 item, as illustrated in block 409. Item is initially priced at $20.00. The Seller 404 receives the bid of $1.00 and the current price of the item decreases to $19.00. Buyer 1 401 is then shown the $19.00 sales price of the item, as illustrated in block 410. The Seller 404 takes no offers for thirty seconds while Buyer 1 401 decides on purchasing the item, as illustrated in block 411. Buyer 1 401 does not take the $19.00 offer to purchase the item and the thirty seconds expire, as illustrated in block 412.

Another potential buyer, Buyer 2 402 bids $1.00 to view the current price of the seller's 404 item, as illustrated in block 413. The Seller 404 receives the bid of $1.00 and the current price of the item decreases to $18.00. Buyer 2 402 is then shown the $18.00 sales price of the item, as illustrated in block 414. The Seller 404 takes no offers for thirty seconds while Buyer 2 402 decides on purchasing the item, as illustrated in block 415. Buyer 2 402 does not take the $18.00 offer to purchase the item and the thirty seconds expire, as illustrated in block 416.

Yet another potential buyer, Buyer 3 403, bids $1.00 to view the current price of the seller's 404 item, as illustrated in block 417. The Seller 404 receives the bid of $1.00 and the current price of the item decreases to $17.00. Buyer 3 403 is then shown the $17.00 sales price of the item, as illustrated in block 418. The Seller 404 takes no offers for thirty seconds while Buyer 3 403 decides on purchasing the item, as illustrated in block 419. Buyer 3 403 decides to accept the $17.00 offer to purchase the item and the auction ends, as illustrated in block 420. The previous offers (e.g., $19.00 and $18.00) are invalid.

Based on the foregoing, it can be appreciated that varying embodiments are disclosed herein, including preferred and alternative embodiments. For example, in one embodiment, a reverse bidding method can be implemented. Such a method can include, for example, bidding to reveal a price of an item during an auction, the price hidden from view, decreasing the price of the item by the amount of the bid, and revealing the decreased price of the item.

In another embodiment, an operation can be implemented for purchasing the item at the price decreased by the amount of the bid. In still another embodiment, an operation can be implemented for bidding to reveal an availability status of the item during the auction. In yet other embodiments, an operation can be implemented for allotting wait time to purchase the item following the bid. In other embodiments, an operation can be implemented for refusing to accept another bid to view the price of the item during the allotted wait time. In another embodiment, an operation can be implemented for selling the item to the last bidder when the price of the item decreases to $0.00. In other embodiments, the item comprises at least one of a good, a product, and a service. In still other embodiments, an operation can be implemented for creating and registering a user profile associated with a user for the user to bid on the item.

In other embodiments, a system can be implemented for reverse bidding. Such a system can include, for example, a processor, a data bus coupled to the processor, and a computer-usable tangible storage device storing computer program code, the computer program code comprising program instructions executable by the processor. The program instructions can include program instructions to accept a bid to reveal a price of an item during an auction, the price hidden from view, program instructions to decrease the price of the item by the amount of the bid, and program instructions to reveal the decreased price of the item.

In some embodiments, the aforementioned instructions executable by the processor can be further configured to purchase the item at the price decreased by the amount of the bid. In other embodiments of such a system, the aforementioned instructions executable by the processor can be further configured to accept a bid to reveal an availability status of the item during the auction. In still other embodiments of such a system, the aforementioned instructions executable by the processor can be further configured to allot wait time to purchase the item following the bid.

In yet other embodiments, the aforementioned instructions executable by the processor can be further configured to refuse to accept another bid to view the price of the item during the allotted wait time. In still other embodiments, the aforementioned instructions executable by the processor can be further configured to sell the item to the last bidder when the price of the item decreases to $0.00. In still other embodiments of such a system, the item comprises at least one of a good, a product, and a service. In other embodiments of such a system, the aforementioned instructions executable by the processor can be further configured to create and register a user profile associated with a user for the user to bid on the item.

In still another embodiment, a computer-usable tangible storage apparatus storing computer program code can be implemented to perform a method for reverse bidding. The program instructions can include program instructions to accept a bid to reveal a price of an item during an auction, the price hidden from view and the item comprising at least one of a good, a product, and a service, program instructions to decrease the price of the item by the amount of the bid, and program instructions to reveal the decreased price of the item.

In another embodiment of such an apparatus, such a method can include, for example, allotting wait time to purchase the item following the bid, wherein another bid to view the price of the item during said allotted wait time is refused. In yet other embodiments of such an apparatus, the aforementioned method can include, for example, selling the item to the last bidder when the price of the item decreases to $0,00. In still other embodiments of such an apparatus the aforementioned method can include, for example, creating and registering a user profile associated with a user for the user to bid on the item.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A reverse bidding method, comprising:
bidding to reveal a price of an item during an auction, said price hidden from view;
decreasing said price of said item by an amount of said bid; and
revealing said decreased price of said item.

2. The method of claim 1, further comprising purchasing said item at said price decreased by said amount of said bid.

3. The method of claim 1, further comprising bidding to reveal an availability status of said item during said auction.

4. The method of claim 1, further comprising allotting wait time to purchase said item following said bid.

5. The method of claim 4, further comprising refusing to accept another bid to view said price of said item during said allotted wait time.

6. The method of claim 1, further comprising selling said item to the last bidder when said price of said item decreases to $0.00.

7. The method of claim 1, wherein said item comprises at least one of a good, a product, and a service.

8. The method of claim 1, further comprising creating and registering a user profile associated with a user for said user to bid on said item.

9. A reverse bidding system, comprising:
a processor;
a data bus coupled to said processor; and
a computer-usable tangible storage device storing computer program code, said computer program code comprising program instructions executable by said processor, said program instructions comprising:
program instructions to accept a bid to reveal a price of an item during an auction, said price hidden from view;
program instructions to decrease said price of said item by said amount of said bid; and
program instructions to reveal said decreased price of said item,

10. The system of claim 9, wherein said program instructions further comprise program instructions to purchase said item at said price decreased by said amount of said bid.

11. The system of claim 9, wherein said program instructions further comprise program instructions to accept said bid to reveal an availability status of said item during said auction.

12. The system of claim 9, wherein said program instructions further comprise program instructions to allot wait time to purchase said item following said bid.

13. The system of claim 12, wherein said program instructions further comprise program instructions to refuse to accept another bid to view said price of said item during said allotted wait time,

14. The system of claim 9, wherein said program instructions further comprise program instructions to sell said item to the last bidder when said price of said item decreases to $0.00.

15. The system of claim 9, wherein said item comprises at least one of a good, a product, and a service.

16. The system of claim 9, wherein said program instructions further comprise program instructions to create and register a user profile associated with a user for said user to bid on said item.

17. A computer-usable tangible storage apparatus storing computer program code, said computer program code comprising program instructions executable by a processor, said program instructions comprising:
program instructions to accept a bid to reveal a price of an item during an auction, said price hidden from view and said item comprising at least one of a good, a product, and a service;
program instructions to decrease said price of said item by an amount of said bid; and
program instructions to reveal said decreased price of said item.

18. The computer-usable tangible storage apparatus of claim 17, wherein said program instructions further comprise program instructions to:
allot wait time to purchase said item following said bid, wherein another bid to view said price of said item during said allotted wait time is refused.

19. The computer-usable tangible storage apparatus of claim 17, wherein said program instructions further comprise program instructions to sell said item to the last bidder when said price of said item decreases to $0.00.

20. The computer-usable tangible storage apparatus of claim 17, wherein said program instructions further comprise program instructions to create and register a user profile associated with a user for said user to bid on said item.
